(19) United States
(12) Patent Application Publication
(10) Pub. No.: US 2026/0037834 A1
(43) Pub. Date: Feb. 5, 2026

(54) PERFORMING TRANSFORMER-BASED DESIGN VERIFICATION FOR COVERAGE CLOSURE IN PROCESSOR DEVICES

(71) Applicant: Microsoft Technology Licensing, LLC, Redmond, WA (US)

(72) Inventors: Harikrishnan KUMARAPILLAI CHANDRIKAKUTTY, Santa Clara, CA (US); Sirish Kumar MUNIPALLI, Austin, TX (US); Fnu SHASHANK, San Jose, CA (US); Aung Thu HTET, North Billerica, MA (US); Matthew N. PUMAR, San Jose, CA (US); Erik William BERG, Portland, OR (US)

(21) Appl. No.: 18/789,646

(22) Filed: Jul. 30, 2024

(51) Int. Cl. G06N 5/02; G06F 11/27

(52) U.S. Cl. CPC G06N 5/02; G06F 11/27

(57) ABSTRACT

Performing transformer-based design verification for coverage closure in processor devices is disclosed herein. In one exemplary embodiment, a processor device trains an online decision transformer (ODT) using initial trajectories based on regression testing of a Design-Under-Test (DUT). The processor device then performs an online learning phase using the ODT by first generating a plurality of new trajectories. For each new trajectory, the processor device uses the ODT to generate a sequence of actions based on maximizing coverage, transmits the sequence of actions to a testbench environment, receives a corresponding sequence of observed states and a corresponding sequence of coverage metrics from the testbench environment, and generates the new trajectory. The processor device identifies a subset of the new trajectories having a final coverage metric that exceeds a coverage threshold, adds the subset to a replay buffer of the ODT, and retrains the ODT using the replay buffer.

### FIELD OF THE DISCLOSURE

The technology of the disclosure relates to design verification in processor devices, and, more particularly, to more efficiently achieving 100% coverage closure of a Design-Under-Test (DUT).

### BACKGROUND

Design verification refers generally to methodologies for testing hardware designs to ensure proper functionality. One commonly used conventional design verification approach uses a Universal Verification Methodology (UVM) testbench environment. A UVM testbench environment may comprise a stimulus generator that generates stimuli (i.e., inputs) for a Design-Under-Test (DUT) and interacts with the DUT via interfaces; a monitor that observes output from the DUT in response to the stimuli and compares the output to expected behavior; and a coverage analyzer that determines how much of the functionality and code of the DUT have been tested.

The verification process using the UVM testbench environment entails first constructing the UVM testbench based on design specifications for the DUT to target specific functionalities of the DUT. Test scenarios are then written to cover normal operation of the DUT, as well as unusual cases and error handling scenarios. The test scenarios are converted into sequences of stimuli that are transmitted to the DUT. Results received from the DUT are then compared to expected results to evaluate test success, and coverage metrics provided by the UVM environment are collected and used to determine a percentage of code and functionality that were covered by the test scenario. The DUT is considered completely verified when 100% coverage of code and functionality (i.e., coverage closure) has been achieved.

However, design verification using a conventional UVM environment faces challenges. Because the stimuli produced by the UVM environment's stimulus generator are generally created using constrained random transactions, the coverage resulting from test scenarios may not be repeatable. Moreover, the randomness of such stimuli results in difficulty in automatically covering every possible aspect of the DUT. To achieve coverage closure, it may be necessary to manually adjust the stimuli, and/or add directed tests to target uncovered aspects of the DUT. Accordingly, it is desirable to provide a design verification mechanism that is more automated in nature, and that can achieve 100% coverage closure faster than manual approaches.

### SUMMARY

Exemplary embodiments disclosed herein perform transformer-based design verification for coverage closure in processor devices. In this regard, in one exemplary embodiment, a processor device is configured to use an online decision transformer (ODT) to automate and accelerate the design verification and coverage closure process. As used herein, an “online decision transformer” or “ODT” refers to a reinforcement learning (RL) model that is trained using a desired return and sequences of past states to autoregressively predict a next action to achieve the desired return, and that also includes sequence-level entropy regularizers that allow for exploration of new sequences. In embodiments discussed herein, the ODT is trained using past transactions and time data as past states, a next transaction as the predicted action, and increasing coverage levels as the desired return.

In exemplary operation, the processor device trains the ODT using a plurality of initial trajectories that are based on regression testing of a Design-Under-Test (DUT) and that are stored in an offline trajectory database. Each trajectory comprises, e.g., a plurality of sets that each include a state corresponding to one or more previous transactions of the regression testing, an action corresponding to a next transaction of the regression testing, and a return-to-go value corresponding to a coverage metric of the action. The processor device then performs an online learning phase using the ODT by performing a series of operations. The processor device first generates a plurality of new trajectories by executing the ODT to generate a sequence of actions based on maximizing coverage. To generate each new trajectory, the ODT transmits a sequence of actions to a testbench environment (e.g., a SystemVerilog testbench environment, as a non-limiting example). A State/Action/Return-to-Go (SAR) generator of the testbench environment subsequently receives a corresponding sequence of observed states and a corresponding sequence of coverage metrics from the testbench environment. The SAR generator then generates each new trajectory based on the sequence of observed states, the sequence of actions, and the sequence of coverage metrics.

After generating the plurality of new trajectories, the SAR generator identifies a subset of the new trajectories having a final coverage metric that exceeds a coverage threshold, and adds the subset of the new trajectories to the replay buffer of the ODT. In some embodiments, the SAR generator may also update the coverage threshold to a value of a highest final coverage metric of the subset of the plurality of new trajectories. The processor device then retrains the ODT using the replay buffer. The processor device in some embodiments repeats the online learning phase until it is determined that 100% coverage closure of the DUT has been reached.

In some embodiments, before performing the online learning phase, the processor device may perform an offline learning phase. In such embodiments, the processor device executes a trajectory generator that receives the regression results of regression testing of the DUT. The trajectory generator generates the plurality of initial trajectories based on the regression results, and stores the initial trajectories in the offline trajectory database. A replay buffer generator identifies a subset of the initial trajectories having a final coverage metric that exceeds a coverage threshold, and stores the subset of the plurality of initial trajectories in the replay buffer of the ODT.

In some embodiments, the testbench environment includes a stimulus generator that receives the sequence of actions from the ODT, and converts the sequence of actions into a corresponding sequence of stimuli to the DUT. The testbench environment also includes a monitor that determines the corresponding sequence of observed states, and a coverage analyzer that determines the corresponding sequence of coverage metrics. The testbench environment then transmits the sequence of observed states and the sequence of coverage metrics to the SAR generator.

In another exemplary embodiment, a processor device configured to perform transformer-based design verification for coverage closure is provided. The processor device is configured to train an ODT using a plurality of initial trajectories that are based on regression testing of a DUT and that are stored in an offline trajectory database. The processor device is further configured to perform an online learning phase using the ODT by being configured to perform a series of operations. The processor device is also configured to generate a plurality of new trajectories by being configured to perform a series of operations for each new trajectory. The processor device is additionally configured to generate, using the ODT, a sequence of actions based on maximizing coverage. The processor device is further configured to transmit the sequence of actions to a testbench environment. The processor device is also configured to receive, by executing a SAR generator, a corresponding sequence of observed states and a corresponding sequence of coverage metrics from the testbench environment. The processor device is additionally configured to generate, by executing the SAR generator, the new trajectory based on the sequence of observed states, the sequence of actions, and the sequence of coverage metrics. The processor device is further configured to identify, by executing the SAR generator, a subset of the plurality of new trajectories having a final coverage metric that exceeds a coverage threshold. The processor device is also configured to add, by executing the SAR generator, the subset of the plurality of new trajectories to a replay buffer of the ODT. The processor device is additionally configured to retrain the ODT using the replay buffer.

In another exemplary embodiment, a method for performing transformer-based design verification for coverage closure in processor devices is provided. The method comprises training an ODT using a plurality of initial trajectories that are based on regression testing of a DUT and that are stored in an offline trajectory database. The method further comprises performing an online learning phase using the ODT by performing a series of operations. The method also comprises generating a plurality of new trajectories by performing a series of operations for each new trajectory. The method additionally comprises generating, using the ODT, a sequence of actions based on maximizing coverage. The method further comprises transmitting the sequence of actions to a testbench environment. The method also comprises receiving, using a SAR generator, a corresponding sequence of observed states and a corresponding sequence of coverage metrics from the testbench environment. The method additionally comprises generating, using the SAR generator, the new trajectory based on the sequence of observed states, the sequence of actions, and the sequence of coverage metrics. The method further comprises identifying, using the SAR generator, a subset of the plurality of new trajectories having a final coverage metric that exceeds a coverage threshold. The method also comprises adding, using the SAR generator, the subset of the plurality of new trajectories to a replay buffer of the ODT. The method additionally comprises retraining the ODT using the replay buffer.

In another exemplary embodiment, a non-transitory computer-readable medium is provided, the computer-readable medium having stored thereon computer-executable instructions which, when executed by a processor device, cause the processor device to train an ODT using a plurality of initial trajectories that are based on regression testing of a DUT and that are stored in an offline trajectory database. The computer-executable instructions further cause the processor device to perform an online learning phase using the ODT by causing the processor device to perform a series of operations. The computer-executable instructions also cause the processor device to generate a plurality of new trajectories by causing the processor device to perform a series of operations for each new trajectory. The computer-executable instructions additionally cause the processor device to generate, using the ODT, a sequence of actions based on maximizing coverage. The computer-executable instructions further cause the processor device to transmit the sequence of actions to a testbench environment. The computer-executable instructions also cause the processor device to receive, by executing a SAR generator, a corresponding sequence of observed states and a corresponding sequence of coverage metrics from the testbench environment. The computer-executable instructions additionally cause the processor device to generate, by executing the SAR generator, the new trajectory based on the sequence of observed states, the sequence of actions, and the sequence of coverage metrics. The computer-executable instructions further cause the processor device to identify, by executing the SAR generator, a subset of the plurality of new trajectories having a final coverage metric that exceeds a coverage threshold. The computer-executable instructions also cause the processor device to add, by executing the SAR generator, the subset of the plurality of new trajectories to a replay buffer of the ODT. The computer-executable instructions additionally cause the processor device to retrain the ODT using the replay buffer.

Those skilled in the art will appreciate the scope of the present disclosure and realize additional embodiments thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several embodiments of the disclosure, and together with the description serve to explain the principles of the disclosure:

FIG. 1 is a block diagram of an exemplary processor-based device that includes a processor device configured to perform transformer-based design verification for coverage closure;

FIG. 2 is a block diagram illustrating exemplary constituent elements of a trajectory such as the initial trajectories and the new trajectories of FIG. 1, according to some embodiments;

FIGS. 3A-3E provide a flowchart illustrating exemplary operations of the processor device of FIG. 1 for performing transformer-based design verification for coverage closure, according to some embodiments; and

FIG. 4 is a block diagram of an exemplary processor-based device, such as the processor-based device of FIG. 1, that is configured to perform transformer-based design verification for coverage closure.

### DETAILED DESCRIPTION

Exemplary embodiments disclosed herein perform transformer-based design verification for coverage closure in processor devices. In this regard, in one exemplary embodiment, a processor device is configured to use an online decision transformer (ODT) to automate and accelerate the design verification and coverage closure process. As used herein, an “online decision transformer” or “ODT” refers to a reinforcement learning (RL) model that is trained using a desired return and sequences of past states to autoregressively predict a next action to achieve the desired return, and that also includes sequence-level entropy regularizers that allow for exploration of new sequences. In embodiments discussed herein, the ODT is trained using past transactions and time data as past states, a next transaction as the predicted action, and increasing coverage levels as the desired return.

In exemplary operation, the processor device trains the ODT using a plurality of initial trajectories that are based on regression testing of a Design-Under-Test (DUT) and that are stored in an offline trajectory database. Each trajectory comprises, e.g., a plurality of sets that each include a state corresponding to one or more previous transactions of the regression testing, an action corresponding to a next transaction of the regression testing, and a return-to-go value corresponding to a coverage metric of the action. The processor device then performs an online learning phase using the ODT by performing a series of operations. The processor device first generates a plurality of new trajectories by executing the ODT to generate a sequence of actions based on maximizing coverage. To generate each new trajectory, the ODT transmits a sequence of actions to a testbench environment (e.g., a SystemVerilog testbench environment, as a non-limiting example). A State/Action/Return-to-Go (SAR) generator of the testbench environment subsequently receives a corresponding sequence of observed states and a corresponding sequence of coverage metrics from the testbench environment. The SAR generator then generates each new trajectory based on the sequence of observed states, the sequence of actions, and the sequence of coverage metrics.

After generating the plurality of new trajectories, the SAR generator identifies a subset of the new trajectories having a final coverage metric that exceeds a coverage threshold, and adds the subset of the new trajectories to the replay buffer of the ODT. In some embodiments, the SAR generator may also update the coverage threshold to a value of a highest final coverage metric of the subset of the plurality of new trajectories. The processor device then retrains the ODT using the replay buffer. The processor device in some embodiments repeats the online learning phase until it is determined that 100% coverage closure of the DUT has been reached.

In some embodiments, before performing the online learning phase, the processor device may perform an offline learning phase. In such embodiments, the processor device executes a trajectory generator that receives the regression results of regression testing of the DUT. The trajectory generator generates the plurality of initial trajectories based on the regression results, and stores the initial trajectories in the offline trajectory database. A replay buffer generator identifies a subset of the initial trajectories having a final coverage metric that exceeds a coverage threshold, and stores the subset of the plurality of initial trajectories in the replay buffer of the ODT.

In some embodiments, the testbench environment includes a stimulus generator that receives the sequence of actions from the ODT, and converts the sequence of actions into a corresponding sequence of stimuli to the DUT. The testbench environment also includes a monitor that determines the corresponding sequence of observed states, and a coverage analyzer that determines the corresponding sequence of coverage metrics. The testbench environment then transmits the sequence of observed states and the sequence of coverage metrics to the SAR generator.

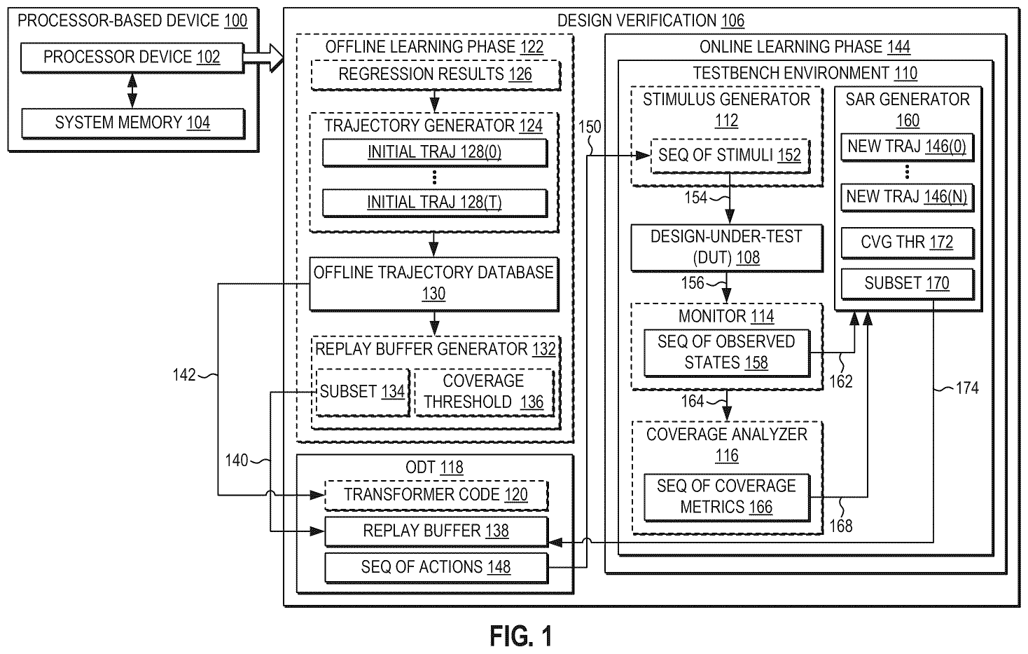

In this regard, FIG. 1 illustrates an exemplary processor-based device 100 that includes a processor device 102 that is communicatively coupled to a system memory 104. The processor device 102 may comprise one or more processor cores (not shown), each of which may include an instruction processing circuit (not shown) comprising an execution pipeline (not shown) for executing computer instructions. It is to be understood that some embodiments of the processor-based device 100 may comprise multiple processor devices 102 rather than the single processor device 102 shown in the example of FIG. 1, and further that the processor-based device 100 may be one of multiple processor-based devices 100, e.g., organized as a cluster.

The processor-based device 100 of FIG. 1 and the constituent elements thereof may encompass any one of known digital logic elements, semiconductor circuits, processing cores, and/or memory structures, among other elements, or combinations thereof. Embodiments described herein are not restricted to any particular arrangement of elements, and the disclosed techniques may be easily extended to various structures and layouts on semiconductor sockets or packages. It is to be understood that some embodiments of the processor-based device 100 may include elements in addition to those illustrated in FIG. 1. For example, the processor device 102 may further include one or more instruction caches, unified caches, controller circuits, interconnect buses, and/or additional memory devices, caches, and/or controller circuits.

In the example of FIG. 1, the processor device 102 is configured to perform a design verification 106 of a DUT 108 by executing a testbench environment 110. The DUT 108 may comprise a circuit, a processor device, or other intellectual property (IP) element comprising hardware and/or firmware. The testbench environment 110 may comprise, e.g., a System Verilog testbench environment. In some embodiments, the testbench environment 110 may comprise elements including a stimulus generator 112, a monitor 114, and a coverage analyzer 116. The stimulus generator 112 is responsible for generating (i.e., inputs) for the DUT 108, and interacts with the DUT 108 via interfaces (not shown) provided by the DUT 108. The monitor 114 observes output from the DUT 108 in response to stimuli and compares the output to expected behavior. The coverage analyzer 116 is responsible for determining coverage metrics that indicate how much of the functionality and code of the DUT 108 have been tested.

In conventional use, the design verification 106 using the testbench environment 110 includes first developing the stimulus generator 112, the monitor 114, the coverage analyzer 116, and other constituent elements of the testbench environment 110 based on design specifications for the DUT 108 to target specific functionalities of the DUT 108. The stimulus generator 112 converts test scenarios that are written to cover normal operation of the DUT 108, as well as unusual cases and error handling scenarios, into sequences of stimuli that are transmitted to the DUT 108. Results received from the DUT 108 are then compared to expected results to evaluate test success, and coverage metrics provided by the testbench environment 110 are collected and used to determine a percentage of code and functionality that were covered by the test scenario. The DUT 108 is considered completely verified when 100% coverage of code and functionality (i.e., coverage closure) has been achieved.

However, as noted above, conventional design verification uses stimuli that are created using constrained random transactions, and consequently the coverage resulting from test scenarios may not be repeatable. In addition, the randomness of such stimuli results in difficulty in automatically covering every possible aspect of the DUT 108. Thus, to achieve coverage closure using conventional approaches, it may be necessary to manually adjust the stimuli, and/or add directed tests to target uncovered aspects of the DUT 108.

Accordingly, embodiments disclosed herein are configured to perform the design verification 106 using an ODT 118 in combination with the testbench environment 110. The ODT 118 is an RL model that employs a transformer architecture similar to that used in, e.g., natural language processing. The ODT 118 comprises transformer code 120 that is configured to process sequences of states, actions, and rewards, which enables the ODT 118 to learn long-term dependencies and to refine its model based on interactions with its environment. As is known in the art, the ODT 118 employs sequence-level entropy regularization to enable exploration of different actions, and uses an autoregressive model to predict future actions based on past observations. In embodiments disclosed herein, the ODT 118 is configured to apply the sequence modeling approach to achieving coverage closure by finding the best set of stimulus sequences (referred to herein as “trajectories”) that will accomplish the greatest coverage. At a high level, the ODT 118 generates new actions based on actions and returns-to-go (i.e., total possible return minus current return values) of a current trajectory. The new actions are used as stimuli to the testbench environment 110. New trajectories, actions, and returns-to-go are provided back to the ODT 118 for retraining, and the process may be repeated until 100% coverage closure of the DUT 108 is reached.

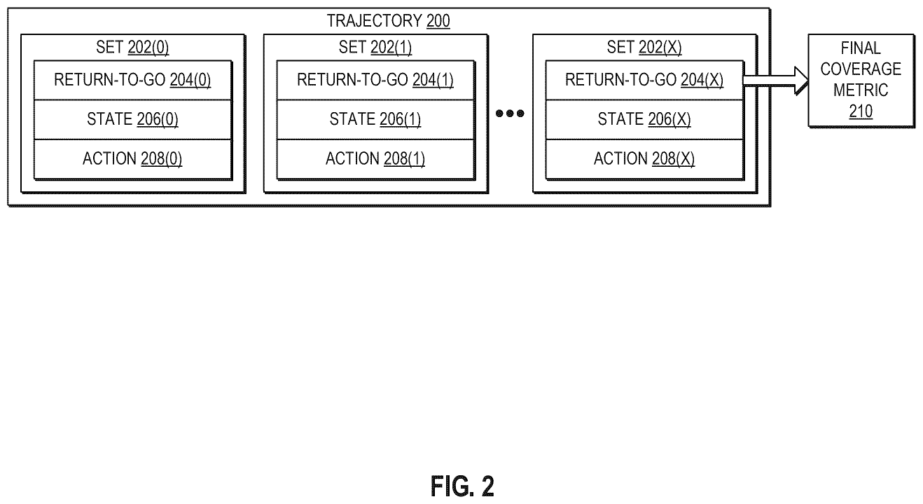

Accordingly, in exemplary operation, the processor device 102 in the example of FIG. 1 first performs an offline learning phase 122. The processor device 102 executes a trajectory generator 124 that receives regression results 126 of regression testing of the DUT 108. The trajectory generator 124 then generates a plurality of initial trajectories (captioned as “INITIAL TRAJ” in FIG. 1) 128(0)-128(T) based on the regression results 126. Each of the initial trajectories 128(0)-128(T) comprises, e.g., a plurality of sets (not shown) that each include a state corresponding to one or more previous transactions of the regression testing, an action corresponding to a next transaction of the regression testing, and a return-to-go value corresponding to a coverage metric of the action. Exemplary elements of trajectories such as the initial trajectories 128(0)-128(T) are discussed below in greater detail with respect to FIG. 2.

The trajectory generator 124 stores the plurality of initial trajectories 128(0)-128(T) in an offline trajectory database 130 for use in performing initial training of the ODT 118. A replay buffer generator 132 then identifies a subset 134 of the plurality of initial trajectories 128(0)-128(T) that have a final coverage metric that exceeds a coverage threshold 136. This subset 134 of the plurality of initial trajectories 128(0)-128(T) is stored in a replay buffer 138 of the ODT 118, as indicated by arrow 140.

The processor device 102 then trains the ODT 118 using the plurality of initial trajectories 128(0)-128(T) stored in the offline trajectory database 130, as indicated by arrow 142. An online learning phase 144 using the ODT 118 then begins. In the online learning phase, the processor device 102 first generates a plurality of new trajectories (captioned as “NEW TRAJ” in FIG. 1) 146(0)-146(N). To generate each new trajectory (such as, e.g., the new trajectory 146(0)), the processor device 102 executes the ODT 118 to generate a sequence of actions (captioned as “SEQ OF ACTIONS” in FIG. 1) 148 based on maximizing coverage. The ODT 118 transmits the sequence of actions 148 to a testbench environment 110, as indicated by arrow 150.

In some embodiments, the stimulus generator 112 of the testbench environment 110 receives the sequence of actions 148. The stimulus generator 112 of the testbench environment 110 converts the sequence of actions 148 into a corresponding sequence of stimuli (captioned as “SEQ OF STIMULI” in FIG. 1) 152 to the DUT 108, as indicated by arrow 154. Output from the DUT 108 is sent to the monitor 114 of the testbench environment 110 (as indicated by arrow 156), which determines a corresponding sequence of observed states (captioned as “SEQ OF OBSERVED STATES” in FIG. 1) 158. The monitor 114 transmits the sequence of observed states 158 to a SAR generator 160 as indicated by arrow 162, and also transmits DUT state information (not shown) to the coverage analyzer 116 of the testbench environment 110, as indicated by arrow 164. The coverage analyzer 116 determines a corresponding sequence of coverage metrics (captioned as “SEQ OF COVERAGE METRICS” in FIG. 1) 166, which is also transmitted to the SAR generator 160, as indicated by arrow 168.

The SAR generator 160 receives the corresponding sequence of observed states 158 and the corresponding sequence of coverage metrics 166. The SAR generator 160 then generates each new trajectory (such as the new trajectory 146(0)) based on the sequence of observed states 158, the sequence of actions 148, and the sequence of coverage metrics 166. The SAR generator 160 also generates a subset 170 of the plurality of new trajectories 146(0)-146(N) that have a final coverage metric that exceeds a coverage threshold (captioned as “CVG THR” in FIG. 1) 172. The SAR generator 160 adds the subset 170 of the plurality of new trajectories 146(0)-146(N) to the replay buffer 138 of the ODT 118, as indicated by arrow 174. In some embodiments, the SAR generator 160 may also update the coverage threshold 136 to a value of a highest final coverage metric of the subset 170 of the plurality of new trajectories 146(0)-146(N). The processor device 102 then retrains the ODT 118 using the replay buffer 138. According to some embodiments, the processor device 102 may determine whether 100% coverage closure of the DUT 108 has been reached. If not, the online learning phase 144 is repeated.

FIG. 2 illustrates an exemplary trajectory 200 that corresponds to each of the initial trajectories 128(0)-128(T) and the new trajectories 146(0)-146(N) of FIG. 1. As seen in FIG. 2, the trajectory 200 comprises a plurality of sets 202(0)-202(X). Each of the sets 202(0)-202(X) comprises a corresponding return-to-go 204(0)-204(X), a corresponding state 206(0)-206(X), and a corresponding action 208(0)-208(X). Each of the states 206(0)-206(X) represents a state that corresponds to one or more previous transactions of the regression testing, and may further comprise, e.g., time data, while each of the actions 208(0)-208(X) represents a next transaction of the regression testing. Each return-to-go 204(0)-204(X) corresponds to a coverage metric of the corresponding action 208(0)-208(X), and represents return remaining in the trajectory 200. When the trajectory 200 is completed, a final coverage metric 210 (i.e., a final return) can be determined. The final coverage metric 210 represents a percentage of coverage of the DUT 108 that is accomplished by the trajectory 200.

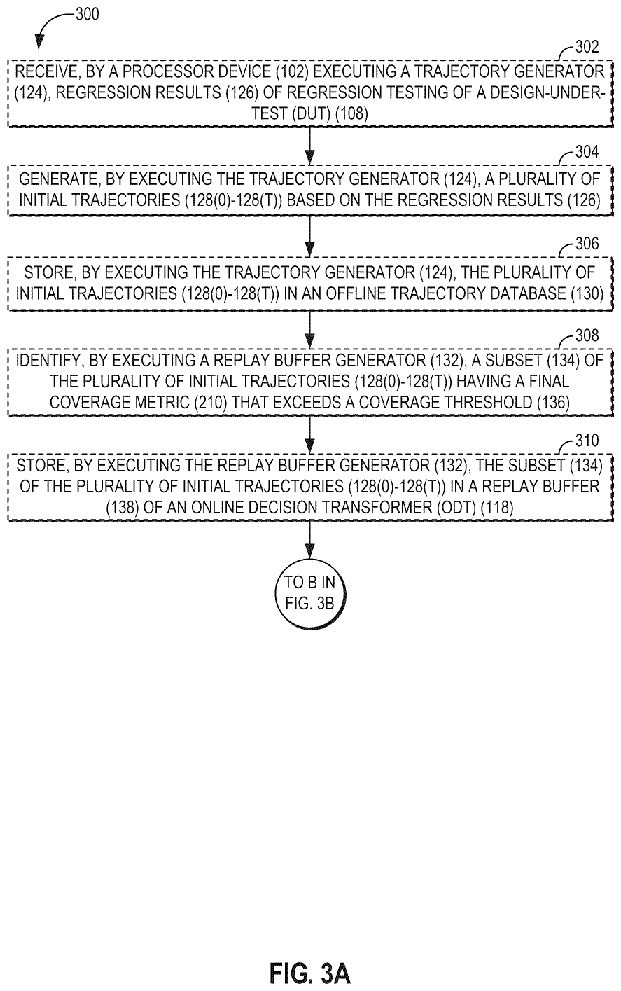

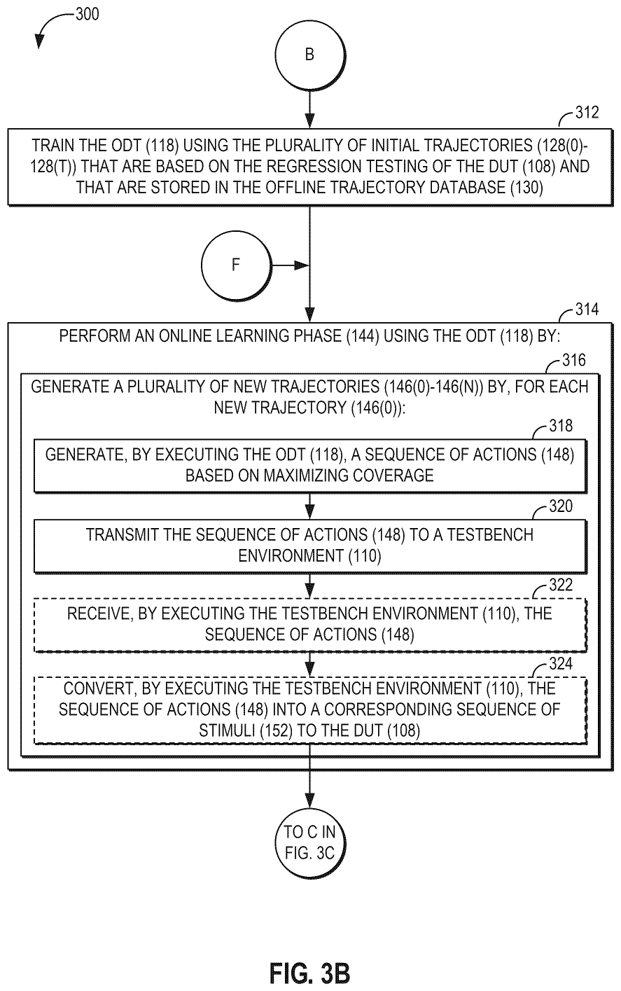

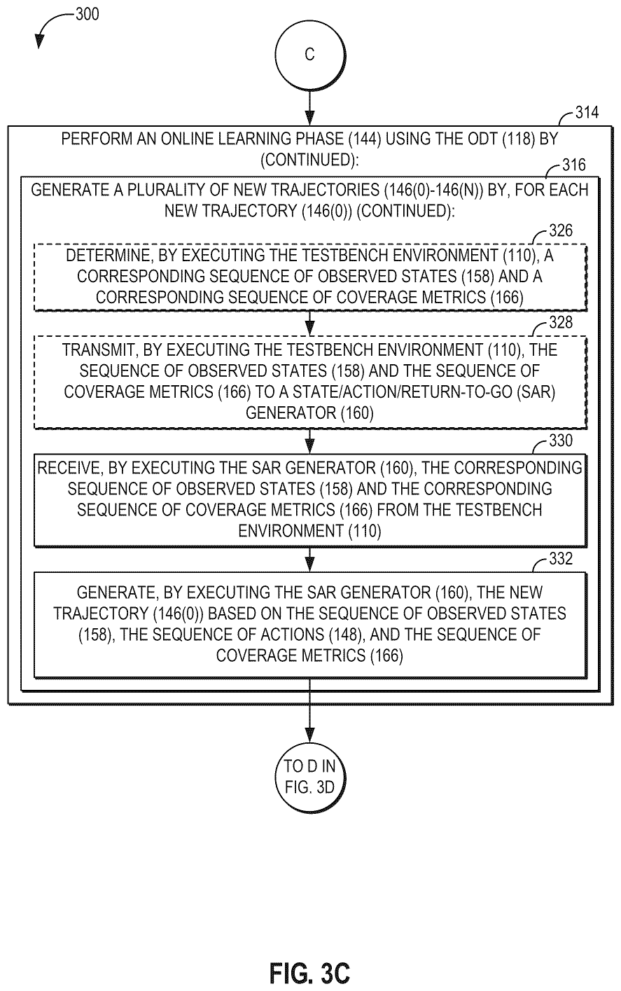

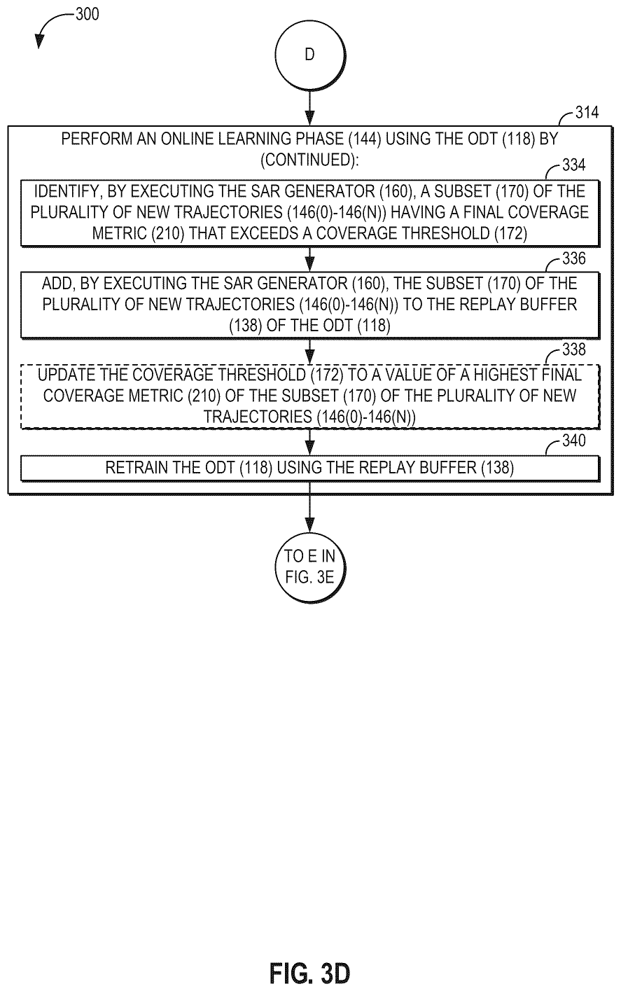

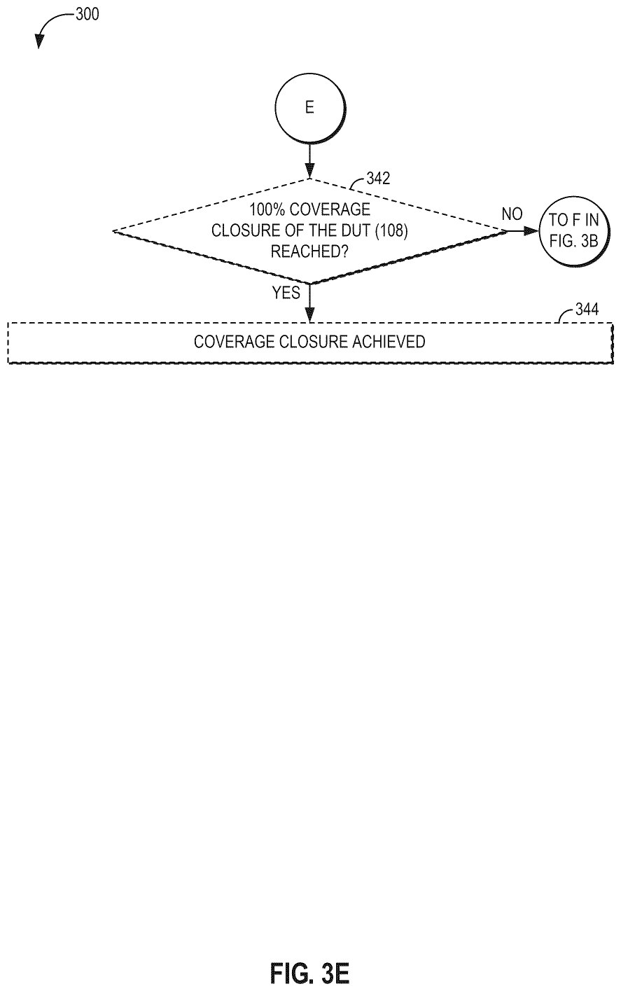

FIGS. 3A-3E provide a flowchart illustrating exemplary operations 300 of processor device 102 of FIG. 1 for performing transformer-based design verification for coverage closure, according to some embodiments. For the sake of clarity, elements of FIGS. 1 and 2 are referenced in describing FIGS. 3A-3E. It is to be understood that some operations illustrated in FIGS. 3A-3E may occur in an order other than that illustrated in FIGS. 3A-3E in some embodiments, and/or may be omitted in some embodiments.

In FIG. 3A, the exemplary operations 300 in some embodiments begin with a processor device (e.g., the processor device 102 of FIG. 1), executing a trajectory generator (such as the trajectory generator 124 of FIG. 1), receiving regression results (e.g., the regression results 126 of FIG. 1) of regression testing of a DUT (such as the DUT 108 of FIG. 1) (block 302). The trajectory generator 124 generates a plurality of initial trajectories (e.g., the initial trajectories 128(0)-128(T) of FIG. 1) based on the regression results 126 (block 304). The trajectory generator 124 then stores the plurality of initial trajectories 128(0)-128(T) in an offline trajectory database (such as the offline trajectory database 130 of FIG. 1) (block 306).

The replay buffer generator 132 next identifies a subset (e.g., the subset 134 of FIG. 1) of the plurality of initial trajectories 128(0)-128(T) having a final coverage metric (such as the final coverage metric 210 of FIG. 2) that exceeds a coverage threshold (e.g., the coverage threshold 136 of FIG. 1) (block 308). The replay buffer generator 132 stores the subset 134 of the plurality of initial trajectories 128(0)-128(T) in a replay buffer (such as the replay buffer 138 of FIG. 1) of an ODT (e.g., the ODT 118 of FIG. 1) (block 310). The exemplary operations 300 then continue at block 312 of FIG. 3B.

Referring now to FIG. 3B, the processor device 102 next trains the ODT 118 using the plurality of initial trajectories 128(0)-128(T) that are based on the regression testing of the DUT 108 and that are stored in the offline trajectory database 130 (block 312). The processor device 102 then performs an online learning phase (such as the online learning phase 144 of FIG. 1) using the ODT 118 by performing a series of operations (block 314). The processor device 102 first generates a plurality of new trajectories (e.g., the new trajectories 146(0)-146(N) of FIG. 1) by performing a series of operations for each new trajectory (such as the new trajectory 146(0) of FIG. 1) (block 316). The processor device 102 executes the ODT 118 to generate a sequence of actions (e.g., the sequence of actions 148 of FIG. 1) based on maximizing coverage (block 318). The ODT 118 transmits the sequence of actions 148 to a testbench environment (such as the testbench environment 110 of FIG. 1) (block 320).

In some embodiments, the testbench environment 110 (for example, a stimulus generator of the testbench environment 110, such as the stimulus generator 112 of FIG. 1) receives the sequence of actions 148 (block 322). The testbench environment 110 converts the sequence of actions 148 into a corresponding sequence of stimuli (e.g., the sequence of stimuli 152 of FIG. 1) to the DUT 108 (block 324). The exemplary operations 300 then continue at block 326 of FIG. 3C.

Turning now to FIG. 3C, the testbench environment 110 next determines a corresponding sequence of observed states (such as the sequence of observed states 158 of FIG. 1, using a monitor of the testbench environment 110 such as the monitor 114) and a corresponding sequence of coverage metrics (e.g., the sequence of coverage metrics 166 of FIG. 1, using a coverage analyzer of the testbench environment 110 such as the coverage analyzer 116 of FIG. 1) (block 326). The testbench environment 110 transmits the sequence of observed states 158 and the sequence of coverage metrics 166 to an SAR generator (such as the SAR generator 160 of FIG. 1) (block 328). The SAR generator 160 receives the corresponding sequence of observed states 158 and the corresponding sequence of coverage metrics 166 from the testbench environment 110 (block 330). The SAR generator 160 then generates the new trajectory 146(0) based on the sequence of observed states 158, the sequence of actions 148, and the sequence of coverage metrics 166 (block 332). The exemplary operations 300 then continue at block 334 of FIG. 3D.

With reference now to FIG. 3D, the SAR generator 160 identifies a subset (e.g., the subset 170 of FIG. 1) of the plurality of new trajectories 146(0)-146(N) having a final coverage metric (such as the final coverage metric 210 of FIG. 2) that exceeds a coverage threshold (e.g., the coverage threshold 172 of FIG. 1) (block 334). The SAR generator 160 then adds the subset 170 of the plurality of new trajectories 146(0)-146(N) to the replay buffer 138 of the ODT 118 (block 336). In some embodiments, the SAR generator 160 may also update the coverage threshold 172 to a value of a highest final coverage metric 210 of the subset 170 of the plurality of new trajectories 146(0)-146(N) (block 338). The processor device 102 then retrains the ODT 118 using the replay buffer 138 (block 340). The exemplary operations 300 according to some embodiments may continue at block 342 of FIG. 3E.

Turning now to FIG. 3E, the processor device 102 in some embodiments may determine whether 100% coverage closure of the DUT 108 has been reached (block 342). If not, the exemplary operations 300 continue at block 314, where the online learning phase 144 is repeated. If the processor device 102 determines at decision block 342 that 100% coverage closure of the DUT 108 has been reached, the exemplary operations conclude at block 344.

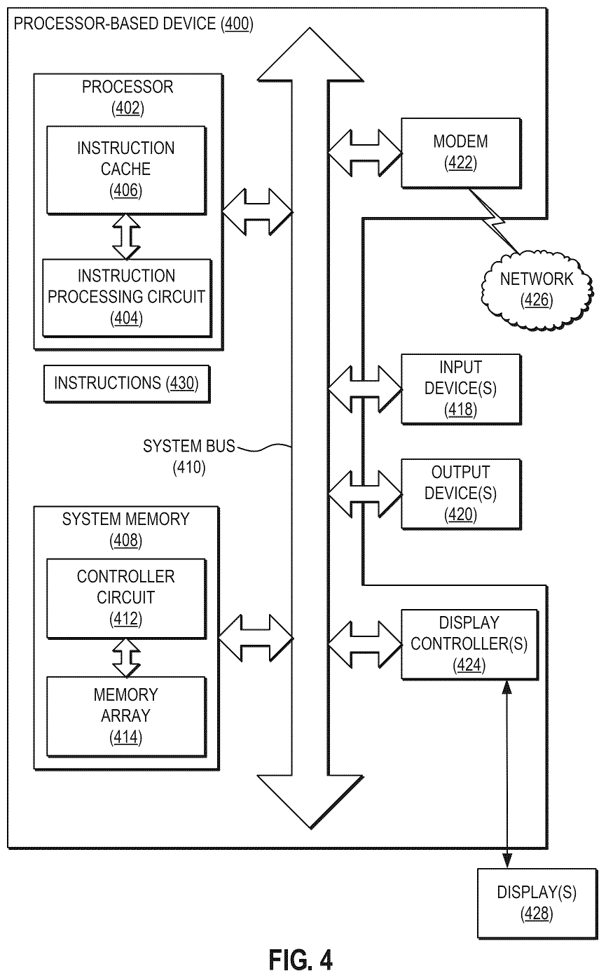

FIG. 4 is a block diagram of an exemplary processor-based device 400 that includes a processor 402 (e.g., a microprocessor) that includes an instruction processing circuit 404. The processor-based device 400 can be the processor-based device 100 in FIG. 1 as an example. The processor-based device 400 may be a circuit or circuits included in an electronic board card, such as a printed circuit board (PCB), a server, a personal computer, a desktop computer, a laptop computer, a personal digital assistant (PDA), a computing pad, a mobile device, or any other device, and may represent, for example, a server, or a user's computer.

In this example, the processor 402 represents one or more general-purpose processing circuits, such as a microprocessor, central processing unit, or the like. The processor 402 is configured to execute processing logic in instructions for performing the operations and steps discussed herein. In this example, the processor 402 includes an instruction cache 406 for temporary, fast access memory storage of instructions accessible by the instruction processing circuit 404. Fetched or prefetched instructions from a memory, such as from the system memory 408 over a system bus 410, are stored in the instruction cache 406. The instruction processing circuit 404 is configured to process instructions fetched into the instruction cache 406 and process the instructions for execution.

The processor 402 and the system memory 408 are coupled to the system bus 410 and can intercouple peripheral devices included in the processor-based device 400. As is well known, the processor 402 communicates with these other devices by exchanging address, control, and data information over the system bus 410. For example, the processor 402 can communicate bus transaction requests to a controller circuit 412 in the system memory 408 as an example of a subordinate device. Although not illustrated in FIG. 4, multiple system buses 410 could be provided, wherein each system bus constitutes a different fabric. In this example, the controller circuit 412 is configured to provide memory access requests to a memory array 414 in the system memory 408. The memory array 414 is comprised of an array of storage bit cells for storing data. The system memory 408 may be a read-only memory (ROM), flash memory, dynamic random access memory (DRAM), such as synchronous DRAM (SDRAM), etc., and a static memory (e.g., flash memory, static random access memory (SRAM), etc.), as non-limiting examples.

Other devices can be connected to the system bus 410. As illustrated in FIG. 4, these devices can include the system memory 408, one or more input device(s) 418, one or more output device(s) 420, a modem 422, and one or more display controllers 424, as examples. The input device(s) 418 can include any type of input device, including but not limited to input keys, switches, voice processors, etc. The output device(s) 420 can include any type of output device, including but not limited to audio, video, other visual indicators, etc. The modem 422 can be any device configured to allow exchange of data to and from a network 426. The network 426 can be any type of network, including but not limited to a wired or wireless network, a private or public network, a local area network (LAN), a wireless local area network (WLAN), a wide area network (WAN), a BLUETOOTH™ network, and the Internet. The modem 422 can be configured to support any type of communications protocol desired. The processor 402 may also be configured to access the display controller(s) 424 over the system bus 410 to control information sent to one or more displays 428. The display(s) 428 can include any type of display, including but not limited to a cathode ray tube (CRT), a liquid crystal display (LCD), a plasma display, etc.

The processor-based device 400 in FIG. 4 may include a set of instructions 430 to be executed by the processor 402 for any application desired according to the instructions. The instructions 430 may be stored in the system memory 408, processor 402, and/or instruction cache 406 as examples of a non-transitory computer-readable medium. The instructions 430 may also reside, completely or at least partially, within the system memory 408 and/or within the processor 402 during their execution. The instructions 430 may further be transmitted or received over the network 426 via the modem 422.

While the computer-readable medium is described herein in an exemplary embodiment to be a single medium, the term “computer-readable medium” should be taken to include a single medium or multiple media (e.g., a centralized or distributed database, and/or associated caches and servers) that stores the one or more sets of instructions. The term “computer-readable medium” shall also be taken to include any medium that is capable of storing, encoding, or carrying a set of instructions for execution by the processing device and that causes the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software process.

The embodiments disclosed herein may be provided as a computer program product, or software process, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.), and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the processor-based devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A processor device, configured to:
train an online decision transformer (ODT) using a plurality of initial trajectories that are based on regression testing of a Design-Under-Test (DUT) and that are stored in an offline trajectory database; and
perform an online learning phase using the ODT by being configured to:
generate a plurality of new trajectories by being configured to, for each new trajectory:
generate, using the ODT, a sequence of actions based on maximizing coverage;
transmit the sequence of actions to a testbench environment;
receive, by executing a State/Action/Return-to-Go (SAR) generator, a corresponding sequence of observed states and a corresponding sequence of coverage metrics from the testbench environment; and
generate, by executing the SAR generator, the new trajectory based on the sequence of observed states, the sequence of actions, and the sequence of coverage metrics;
identify, by executing the SAR generator, a subset of the plurality of new trajectories having a final coverage metric that exceeds a coverage threshold;
add, by executing the SAR generator, the subset of the plurality of new trajectories to a replay buffer of the ODT; and
retrain the ODT using the replay buffer.

2. The processor device of claim 1, wherein:
each trajectory of the plurality of initial trajectories and the plurality of new trajectories comprises a plurality of sets; and
each set of each plurality of sets comprises:
a state corresponding to one or more previous transactions of the regression testing;
an action corresponding to a next transaction of the regression testing; and
a return-to-go value corresponding to a coverage metric of the action.

3. The processor device of claim 1, wherein the processor device is configured to perform the online learning phase using the ODT by being further configured to:
determine whether 100% coverage closure of the DUT has been reached; and
responsive to determining that 100% coverage closure of the DUT has not been reached, repeat the online learning phase.

4. The processor device of claim 1, wherein the processor device is further configured to:
receive, by executing a trajectory generator, regression results of the regression testing;
generate, by executing the trajectory generator, the plurality of initial trajectories based on the regression results;
store, by executing the trajectory generator, the plurality of initial trajectories in the offline trajectory database;
identify, by executing a replay buffer generator, a subset of the plurality of initial trajectories having a final coverage metric that exceeds the coverage threshold; and
store, by executing the replay buffer generator, the subset of the plurality of initial trajectories in the replay buffer of the ODT.

5. The processor device of claim 1, wherein the processor device is further configured to:
receive, by executing the testbench environment, the sequence of actions;
convert, by executing the testbench environment, the sequence of actions into a corresponding sequence of stimuli to the DUT;
determine, by executing the testbench environment, the sequence of observed states and the sequence of coverage metrics; and
transmit, by executing the testbench environment, the sequence of observed states and the sequence of coverage metrics to the SAR generator.

6. The processor device of claim 1, wherein the testbench environment comprises a System Verilog testbench environment.

7. The processor device of claim 1, wherein the processor device is further configured to update the coverage threshold to a value of a highest final coverage metric of the subset of the plurality of new trajectories.

8. A method for performing transformer-based design verification for coverage closure in processor devices, comprising:
training an online decision transformer (ODT) using a plurality of initial trajectories that are based on regression testing of a Design-Under-Test (DUT) and that are stored in an offline trajectory database; and
performing an online learning phase using the ODT by:
generating a plurality of new trajectories by, for each new trajectory:
generating, using the ODT, a sequence of actions based on maximizing coverage;
transmitting the sequence of actions to a testbench environment;
receiving, using a State/Action/Return-to-Go (SAR) generator, a corresponding sequence of observed states and a corresponding sequence of coverage metrics from the testbench environment; and
generating, using the SAR generator, the new trajectory based on the sequence of observed states, the sequence of actions, and the sequence of coverage metrics;
identifying, using the SAR generator, a subset of the plurality of new trajectories having a final coverage metric that exceeds a coverage threshold;
adding, using the SAR generator, the subset of the plurality of new trajectories to a replay buffer of the ODT; and
retraining the ODT using the replay buffer.

9. The method of claim 8, wherein:
each trajectory of the plurality of initial trajectories and the plurality of new trajectories comprises a plurality of sets; and
each set of each plurality of sets comprises:
a state corresponding to one or more previous transactions of the regression testing;
an action corresponding to a next transaction of the regression testing; and
a return-to-go value corresponding to a coverage metric of the action.

10. The method of claim 8, wherein performing the online learning phase using the ODT further comprises:
determining whether 100% coverage closure of the DUT has been reached; and
responsive to determining that 100% coverage closure of the DUT has not been reached, repeating the online learning phase.

11. The method of claim 8, further comprising:
receiving, using a trajectory generator, regression results of the regression testing;
generating, using the trajectory generator, the plurality of initial trajectories based on the regression results;
storing, using the trajectory generator, the plurality of initial trajectories in the offline trajectory database;
identifying, using a replay buffer generator, a subset of the plurality of initial trajectories having a final coverage metric that exceeds the coverage threshold; and
storing, using the replay buffer generator, the subset of the plurality of initial trajectories in the replay buffer of the ODT.

12. The method of claim 8, further comprising:
receiving, using the testbench environment, the sequence of actions;
converting, using the testbench environment, the sequence of actions into a corresponding sequence of stimuli to the DUT;
determining, using the testbench environment, the sequence of observed states and the sequence of coverage metrics; and
transmitting, using the testbench environment, the sequence of observed states and the sequence of coverage metrics to the SAR generator.

13. The method of claim 8, wherein the testbench environment comprises a System Verilog testbench environment.

14. The method of claim 8, further comprising updating the coverage threshold to a value of a highest final coverage metric of the subset of the plurality of new trajectories.

15. A non-transitory computer-readable medium, having stored thereon computer-executable instructions that, when executed by a processor device, causes the processor device to:
train an online decision transformer (ODT) using a plurality of initial trajectories that are based on regression testing of a Design-Under-Test (DUT) and that are stored in an offline trajectory database; and
perform an online learning phase using the ODT by causing the processor device to:
generate a plurality of new trajectories by causing the processor device to, for each new trajectory:
generate, using the ODT, a sequence of actions based on maximizing coverage;
transmit the sequence of actions to a testbench environment;
receive, by executing a State/Action/Return-to-Go (SAR) generator, a corresponding sequence of observed states and a corresponding sequence of coverage metrics from the testbench environment; and
generate, by executing the SAR generator, the new trajectory based on the sequence of observed states, the sequence of actions, and the sequence of coverage metrics;
identify, by executing the SAR generator, a subset of the plurality of new trajectories having a final coverage metric that exceeds a coverage threshold;
add, by executing the SAR generator, the subset of the plurality of new trajectories to a replay buffer of the ODT; and
retrain the ODT using the replay buffer.

16. The non-transitory computer-readable medium of claim 15, wherein:
each trajectory of the plurality of initial trajectories and the plurality of new trajectories comprises a plurality of sets; and
each set of each plurality of sets comprises:
a state corresponding to one or more previous transactions of the regression testing;
an action corresponding to a next transaction of the regression testing; and
a return-to-go value corresponding to a coverage metric of the action.

17. The non-transitory computer-readable medium of claim 15, wherein the computer-executable instructions cause the processor device to perform the online learning phase using the ODT by further causing the processor device to:
determine whether 100% coverage closure of the DUT has been reached; and
responsive to determining that 100% coverage closure of the DUT has not been reached, repeat the online learning phase.

18. The non-transitory computer-readable medium of claim 15, wherein the computer-executable instructions further cause the processor device to:
receive, by executing a trajectory generator, regression results of the regression testing;
generate, by executing the trajectory generator, the plurality of initial trajectories based on the regression results;
store, by executing the trajectory generator, the plurality of initial trajectories in the offline trajectory database;
identify, by executing a replay buffer generator, a subset of the plurality of initial trajectories having a final coverage metric that exceeds the coverage threshold; and
store, by executing the replay buffer generator, the subset of the plurality of initial trajectories in the replay buffer of the ODT.

19. The non-transitory computer-readable medium of claim 15, wherein the computer-executable instructions further cause the processor device to:
receive, by executing the testbench environment, the sequence of actions;
convert, by executing the testbench environment, the sequence of actions into a corresponding sequence of stimuli to the DUT;
determine, by executing the testbench environment, the sequence of observed states and the sequence of coverage metrics; and
transmit, by executing the testbench environment, the sequence of observed states and the sequence of coverage metrics to the SAR generator.

20. The non-transitory computer-readable medium of claim 15, wherein the computer-executable instructions further cause the processor device to update the coverage threshold to a value of a highest final coverage metric of the subset of the plurality of new trajectories.
